(19) United States
(12) Patent Application Publication
(10) Pub. No.: US 2012/0272845 A1
(43) Pub. Date: Nov. 1, 2012

(54) APPARATUS AND METHODS FOR PREPARING IDENTIFICATION FEATURES INCLUDING PHARMACEUTICAL APPLICATIONS

(75) Inventors: Cedric Loiret-Bernal, Evanston, IL (US); Bjoern Rosner, Chicago, IL (US); Sylvain Cruchon-Dupeyrat, Chicago, IL (US); John E. Bussan, Naperville, IL (US); Michael Nelson, Libertyville, IL (US)

(73) Assignee: NanoInk, Inc.

(21) Appl. No.: 13/539,259

(22) Filed: Jun. 29, 2012

Related U.S. Application Data
(63) Continuation of application No. 11/305,327, filed on Dec. 19, 2005.
(60) Provisional application No. 60/637,007, filed on Dec. 20, 2004.

(51) Int. Cl. B44B 5/00

(52) U.S. Cl. 101/11

(57) ABSTRACT

Semi-automated or automated manufacturing of micro- or nanostructured identification features on objects and compositions, and especially pharmaceutical compositions. In particular, a motorized stamping apparatus capable of precise hot embossing with or without closed-loop control of the loading; a modular stamp head for a high-throughput parallel stamping apparatus that comprise an array of compact, error-tolerant, individually temperature-controllable stamping elements; inexpensive stamp holders for said elements, as well as associated methods. The inventive features do not reside in the method of making the stamps.

### RELATED APPLICATIONS

This application claims the benefit of provisional application Ser. No. 60/637,007 filed Dec. 20, 2004, which is hereby incorporated by reference in its entirety.

### BACKGROUND

A need exists to provide for better protection and security against counterfeiting and grey-market goods, particularly for consumer goods and pharmaceuticals. Estimates suggest that hundreds of billions of dollars a year are lost on counterfeit goods of one sort or another. Technology to prevent this should be difficult to replicate or simulate; difficult to alter, transpose, or tamper; easily recognizable by user in either overt or covert form; verifiable by manufacturer or issuer; easily applicable to product or document; and cost effective. For pharmaceutical applications, the technology should also not compromise the safety of the pharmaceutical and must meet federal regulations. Durability and flexibility in the technological goods are important.

Although many advances have recently been made in preparing nanostructures, microstructures, and other fine structures too small for the eye to see, in general, these advances have been underappreciated with respect to solving problems in counterfeiting and authentication, particularly in the pharmaceutical industry. Moving to the nanoscale can result in precision and accuracy requirements which prior art methods cannot provide.

In particular, a need exists for better instrumentation and subassemblies for instruments which can provide solutions to these and other problems, particularly in the pharmaceutical industry. They should provide the best balance of quality, speed, and cost for a particular application, especially for the pharmaceutical industry and myriad, various pharmaceutical drugs in different forms. In other words, versatility is important. While printing methods can be used, for refined imprinting, good dimensional tolerance and control of force are needed which are lacking in the prior art.

A need also exists to come up with methods and business methods or systems to deal with these problems which incorporate advanced technologies which counterfeiters cannot access.

### SUMMARY

The invention, in various embodiments, is described further in this non-limiting summary section.

One embodiment is an instrument for stamping pharmaceutical compositions comprising: (1) a motorized mechanical actuation subsystem, (2) a temperature-regulated stamping subsystem adapted for holding and heating a stamp, (3) an assembly adapted for holding a pharmaceutical composition to be stamped, wherein the motorized mechanical actuation subsystem is adapted to translate the temperature-regulated stamping subsystem at a known speed towards and known positions relative to the pharmaceutical composition.

Another embodiment provides an instrument for stamping of a pharmaceutical composition comprising: (i) a device adapted for coupling with a stamp; (ii) a mount for holding a pharmaceutical composition; wherein the device and the mount are operably coupled for relative motion of the stamp and the pharmaceutical composition and for stamping the pharmaceutical composition with the stamp, wherein the device comprises: (i) a substantially vertical slider controlled by a servo drive; (ii) a spring mechanism attached to the slider with downward spring-loading from the servo slider to the spring slider to compensate for dimensional tolerances and allow for gradual pressure increase; and a temperature-controlled stamp holder adapted for mating with the slider and supporting the stamp, optionally further comprising the stamp, wherein the stamp comprises at least one micro- or nanofabricated identification region for stamping an identification region on the pharmaceutical composition.

Another embodiment is an automated stamping instrument for stamping pharmaceutical compositions in high throughput comprising: a pharmaceutical unit conveyor or rotary table, and a parallel stamp head comprising an array of modular stamping elements, said modular stamping elements comprising: a removable stamp holder holding a stamp; an individual temperature-controlled heating block thermally connected to said stamp holder; and an individually spring-loaded slide that compensates for pharmaceutical unit and mechanism dimensional variations and allows for a gradual increase and decrease of the stamping pressure.

Another embodiment is a parallel stamp head adapted for use in parallel stamping of pharmaceutical compositions at known temperature, pressure, and time comprising: an array of modular stamping elements each comprising: (i) a removable stamp holder holding a stamp; (ii) an individual temperature controlled heating block thermally connected to the stamp holder; (iii) an individually spring-loaded slide that compensates for pharmaceutical unit and mechanism dimensional variations and allows for a gradual increase and decrease of the stamping pressure.

Another embodiment is a parallel stamping head comprising stamping elements each comprising: a mounting block, an easily removable stamp holder, a temperature-control block in good thermal contact with the stamp holder, and a spring and rail subsystem.

Another embodiment is a stamp holder adapted for mounting on a heated stamping element in a stamping instrument for stamping of pharmaceutical compositions, said stamp holder comprising: a body adapted for a quick release mechanical connection to said stamping element and for good thermal contact with a heater within said stamping element, and a stamp at one end.

Also provided is a method for high-throughput manufacturing of objects and compositions having at least one identification region, said identification region having at least one micro- or nanofabricated identification feature, the method comprising the steps of: providing an array of stamps; providing a matching array of objects or compositions; embossing, debossing, engraving, imprinting, or stamping said objects or compositions with said stamps in parallel.

The instruments, in the variety of embodiments, can be used to stamp a pharmaceutical unit composition such as, for example, a pill or a tablet, (1) as part of research and development to engineer a manufacturing process, and (2) as one of the last or the last step in a manufacturing process for anti-counterfeiting purposes.

Advantages include superficial, shallow embossing of the pharmaceutical composition only, e.g., tablet coating, without modification of the tablet core that contains an active pharmaceutical ingredient (API). No chemicals are added so the process is an FDA approvable physical process. The dieholder can be changed with ease. Pressure and temperature can be controlled with high accuracy (e.g., within 2° F. for temperature). Individual control of temperature is possible for different stamp elements. High throughput and good automation is possible. In view of the lack of flat areas and small size of some tablets, the instrument can be designed to use small stamps.

For purposes of this patent application, the inventive features do not reside in the method of making the stamps.

### BRIEF DESCRIPTION OF THE DRAWINGS

FIG. 1 shows a front view of the apparatus used to test temperature, time, and pressure of stamping process.

FIG. 2 shows a front view of an apparatus that may be used to apply identification features.

FIG. 3 shows a perspective view of the apparatus shown in FIG. 2.

FIG. 4 shows an enlarged view of the stamp holder, stamp, and pharmaceutical form mount portions of the apparatus shown in FIG. 3.

FIG. 5 shows schematic of the stamp and pharmaceutical composition during application of identification features.

FIG. 6 highlights the different functional blocks of a semi-automated stamping tool.

FIG. 7 is a schematic diagram of a motorized stamping tool for preparing micro- or nanoencoded pharmaceutical compositions.

FIG. 8 is a detailed view of the collet holder block of the aforementioned semi-automated stamping tool.

FIG. 9 is a photograph of a prototype of [A] the aforementioned semi-automated stamping tool; and [B] collet holder block.

FIG. 10 illustrates [A] an exemplary hardware setup for a semi-automated, closed-loop stamping tool; and [B] a preferred control algorithm (loading profile).

FIG. 11 illustrates a modular stamping element adapted for forming the stamp head of a high-throughput automated stamping tool.

FIG. 12 is a bottom perspective view of a head comprising 80 stamp holder elements, which is adapted for high-throughput automated stamping.

FIG. 13 is another perspective view of the aforementioned 80-element head for high-throughput automated stamping, showing a revised head for use in production.

FIG. 14 illustrates an inexpensive stamp holder adapted to mounting into a high-throughput automated stamping tool.

FIG. 15 is the diagram of a device for the alignment, storage and secure transportation of sets of stamp holders according to FIG. 14.

FIG. 16 charts a method for managing codes, stamps and stamp holders used for the fabrication of pharmaceutical compositions having at least one micro- or nanoscale identification region.

### DETAILED DESCRIPTION

### Introduction/Overview

The references cited herein can be referred to in the practice of the present invention. No admission is made that any of the cited references is prior art.

The invention, in its various embodiments, generally relates to methods and apparatuses for the semi-automated or automated manufacturing of covert and/or overt information-encoding microscale or nanoscale features on objects and compositions, and especially pharmaceutical compositions, for the purpose of, e.g., counterfeiting and grey-market product detection.

In one embodiment, the invention provides a stamping instrument comprising (i) a device which is adapted to be coupled to a stamp; (ii) a mount which is adapted for holding an object or composition, wherein the device and the mount are operably connected to provide relative motion and stamping of the object or composition by the stamp. The stamping instrument can further comprise components for bringing the object or composition to the mount for stamping, and components for bringing the object or composition away from the mount after stamping.

In another embodiment, the invention provides an apparatus for forming identification features to pharmaceutical compositions comprising: a pressure ram; optionally, a stamp attached to the pressure ram for imprinting at least one identification feature on a pharmaceutical composition; a mount for holding at least one non-wafer pharmaceutical composition; and a load cell for measuring the amount of force applied to the at least one pharmaceutical composition; wherein the pressure ram presses the stamp against the at least one pharmaceutical composition held by the pharmaceutical composition mount with a desired amount of force as measured by the load cell to form at least one identification feature on the at least one pharmaceutical composition.

In another embodiment, the invention provides a semi-automated or automated stamping instrument, said instrument comprising: a precision, motorized mechanical actuation subsystem, a temperature-regulated stamping subsystem for holding a stamp, an assembly holding a composition or object, an optional alignment stage to align said composition or object underneath said stamping assembly, where the motorized mechanical actuation subsystem translates the temperature-regulated stamping subsystem at a known speed towards and known positions relative to the composition or object.

In another embodiment, the invention provides a semi-automated stamping instrument, the instrument comprising a substantially vertical slider controlled by a servo drive; a spring mechanism attached to the slider with downward spring-loading from the servo slider to the spring slider to compensate for dimensional tolerances and allow for gradual pressure increase; a temperature-controlled stamp holder supporting a stamp comprising at least one micro- or nanofabricated identification region; and a mating mechanism for the stamp holder. The stamp holder can be made of standard commercial parts (e.g., a collet and collet holder). The semi-automated instrument provides precise control of (i) the temperature of the heating element, and simultaneously (ii) the pressure applied by the stamp, including its increase and decrease rates, and the contact time of said stamp with the pharmaceutical composition; as well as (iii) easy removal and replacement of the stamp; and (iv) higher stamping throughput than a purely manual tool.

In other embodiments, the invention provides methods of manufacturing using the stamping instruments. Another aspect of the invention is making the stamping instrument. The stamping instrument can be adapted and used in closed-loop mode. In this mode, the load is applied during stamping and is measured and fed back to the stamping control system. This allows for stamping parameters to be kept at a desired value or to follow a desired program. Another part of the invention is an algorithm to operate the closed-loop stamping apparatus. A preferred algorithm provides indentation at constant, user-selectable speed until a load threshold is reached. Also provided is dwelling at constant load for a user-selected duration. Also provided is retraction of the stamp at a user-adjustable speed.

In another embodiment, therefore, the invention provides a method for the closed-loop imprinting of identification marks on a composition or object, the method comprising the steps of: providing a stamping instrument comprising a motorized mechanical actuation subsystem and a stamping subsystem, measuring the load applied on a composition or object, feeding its value back to the control system controlling the motorized mechanical actuation subsystem, so that the load or related stamping parameters may be kept at a desired value or according to a desired predetermined program.

Also provided is a method for high-throughput manufacturing of objects and compositions having at least one identification region, said identification region having at least one micro- or nanofabricated identification feature, the method comprising the steps of: providing an array of stamps; providing a matching array of objects or compositions; embossing, debossing, engraving, imprinting, or stamping said objects or compositions with said stamps in parallel. The objects and compositions can be pharmaceutical compositions, and at least 80, preferably at least 200, and preferably at least 500 objects and compositions can be processed in parallel.

In a preferred embodiment, the stamping instrument is adapted and used to process pharmaceuticals, although the non-pharmaceutical compositions and various objects can also be processed with the stamping instrument. The pharmaceutical can be first manufactured and then, post manufacture, modified with the stamping instrument according to the present invention.

Parallel stamping is another important embodiment. For example, the invention also provides a method for embossing, debossing, engraving, imprinting, or stamping without ink and/or print with ink micro- or nanoscale identification regions onto or into at least two pharmaceutical compositions in a parallel fashion. The number is not particularly limited but at least 50, at least 100, or at least 1,000 pharmaceutical compositions can be processed in parallel fashion. The number can be also, for example, 12, 25, or 120.

Also provided is an automated stamping instrument comprising: a high-volume pharmaceutical unit conveyor or rotary table and a parallel stamp head, said stamp head comprising an array of modular stamping elements, said modular stamping elements comprising: a removable stamp holder holding a stamp, an individual temperature-controlled heating block thermally connected to said stamp holder, an individually spring-loaded slide that compensates for pharmaceutical unit and mechanism dimensional variations and allows for a gradual increase and decrease of the stamping pressure, optionally a pressure feedback sensor. The stamp holder can be inexpensive and easily removable.

In another embodiment, the invention provides an inexpensive stamp holder adapted for mounting on a heated stamping element in a stamping instrument, said stamp holder comprising: a body adapted for mechanical connection to said stamping element and for good thermal contact with a heater within said stamping element, a unique identifier, and a stamp. The mechanical connection can be a rapid mechanical connection.

In other embodiments, the invention provides stamp holders and devices for transporting and storing stamp holders. For example, provided herein is a device for securely transporting and storing an array of stamp holders.

In other embodiments, the invention provides business methods which use the stamping processes, the stamping instruments, the stamping holders, or combinations thereof. For example, one embodiment provides a business method for managing a set of stamps adapted for manufacturing object and compositions having at least one micro- or nanoscale identification region, said method comprising the steps of: upon receiving a request for a set of stamps; generating a code associated with data associated with the request; optionally storing said code in a database for later retrieval; converting the code in an equivalent pattern design suitable for micro- or nanofabrication; fabricating a set of stamps having said pattern; mounting said stamps on appropriate stamp holders; shipping securely the resulting stamp holder set to the manufacturing site; installing the target stamping machine with said stamp set; and optionally securely returning the previously installed set to the stamp manufacturing site; accounting for said stamp holders and associated stamps; refurbishing the stamp holders, comprising the step of irreversibly destroying or securely storing said stamps; generating a commercial invoice and associated tracking documentation.

In general, the stamping processes and instruments described herein provide a better alternative to prior art printing processes and instruments. An advantage is that the stamping process can be decoupled from the manufacturing process of the composition or object. This is particularly important for pharmaceutical applications. Hence, it is adaptable to a variety of compositions and objects, because the process is independent of how the composition or object is made.

The invention resides in part in method and apparatus for the high-volume, high-throughput, reproducible and scalable fabrication of covert or overt anti-counterfeiting features on objects and compositions, and especially pharmaceutical compositions, such as tablet, capsules and wafers. As described above, a particular preferred example of the invention is for applications with respect to stamping a pharmaceutical composition, and methods of making the stamped pharmaceutical composition. In general, the various embodiments of the invention can be applied to pharmaceutical goods which are susceptible to counterfeiting, including for example high priced pharmaceuticals, prescription drugs, and blockbuster drugs with large sales volume, wherein price differentials exist from country to country and the economic incentive to counterfeit is high, as described above. The description above for pharmaceutical compositions, and methods of making, generally can be also adapted to apply to other compositions and objects which can be subjected to counterfeiting fraud such as the confectionary compositions and consumer goods like CDs or DVDs.

Hence, the invention also relates to objects and compositions which have a surface, wherein the surface comprises at least one identification region having at least one identification feature. An object broadly can be a variety of items including items of commerce and is not particularly limited by any shape or form. It can be man-made or natural. Typically, an object can have a particular use or function and can comprise one or many compositions. A composition also broadly can be a variety of materials, chemical compounds, elements, mixtures, blends, composites, metals, glasses, polymers, ceramics, and the like and is not limited by a particular use or function. The identification feature on the object or composition can have relatively small lateral and vertical dimensions. The feature can be a positive feature, protruding from the surface, or a negative feature, extending into the surface.

One embodiment, for example, comprises an object comprising: an object having a surface, wherein the surface comprises at least one identification region having at least one identification feature which has a lateral dimension of about 500 microns or less, or alternatively about 100 microns or less, or about 10 microns or less, or about 1 micron or less, or about 500 nm or less, or about 250 nm or less, or about 100 nm or less.

Another embodiment is for a composition comprising: a composition having a surface, wherein the surface comprises at least one identification region having at least one identification feature which has a lateral dimension of about 500 microns or less, or alternatively about 100 microns or less, or about 10 microns or less, or about 1 micron or less, or about 500 nm or less, or about 250 nm or less, or about 100 nm or less.

Preferred examples of objects include currency, consumer products, paper, money, documents, entertainment media, compact disks, DVDs, nickel masters, flat wafers, disk drive heads, semiconductor chips, integrated circuits and their components, aircraft components, aerospace components, mission-critical military components, packaging containers and materials including packaging containers and materials for pharmaceuticals, jewelry, precious raw materials, personal and institutional identification devices, medical devices, bottle tampering-evident seals, syringes, jewelry and collectibles. In particular, syringes, pre-loaded syringes, vaccines and vaccine vials, and injectable drug vials, including bottle seal, medical devices including catheters and implantable devices, and packaging labels can be used. In general, objects which are susceptible to counterfeiting or copying are particularly of use.

Preferred examples of compositions include pharmaceutical, medications, drugs, food, and confectionary.

In general, the composition can be a material which can be imprinted. They can be, for example, thermoplastic materials which can soften with heat and then become hard at lower temperatures. Thermosetting or crosslinking compositions can be also used wherein the material is in a soft form and then subjected to imprinting. Curing or hardening steps can be then carried out to lock in the imprinting.

If desired, a material can be provided with the at least one identification region having at least one identification feature, and then the material can be combined with an API.

### Stamping Instrument Part I: Initial Description

In one embodiment, the invention provides a stamping instrument comprising (i) a device which is adapted to be coupled to a stamp; (ii) a mount which is adapted for holding an object or composition, wherein the device and the mount are operably connected to provide relative motion and stamping of the object or composition by the stamp. For example, the device can be adapted to include a stamp holder which holds the stamp for use in stamping. For purposes of this patent application, the inventive features do not reside in the method of making the stamps.

The stamp can be an object which creates impressions for identification features when pressed into the object or composition. For example, a positive protrusion in the stamp can create a negative reverse image in the composition or object. Alternatively, a negative image in the stamp can create a positive reverse image in the composition or object. An important aspect of the present invention is that the stamp comprise small features, which renders protection against counterfeiting and safeguards security. Small features can be prepared by, for example, microlithography and nanolithography including direct-write methods and direct-write nanolithography, including for example electron beam lithography and various kinds of optical lithography. In addition, for example, DPN printing technology and etching procedures to form nanostructures useful as stamps are described in pending patent application to Mirkin et al. “Fabrication of Solid-State Nanostructures including sub-50 nm Solid-State Nanostructures Based on Nanolithography and Chemical Etching” filed Dec. 3, 2003 (Ser. No. 10/725,939), which is hereby incorporated by reference in its entirety. (DPN and DIP PEN NANOLITHOGRAPHY are trademarks of NanoInk.) This application also describes a series of geometric patterns which can be used for the identification features.

The stamping instrument can further comprise components for bringing the object or composition to the mount for stamping, and components for bringing the object or composition away from the mount after stamping.

In general, stamping instruments and components for stamping such as stamps are commercially available. They range from automatic production machines to manual research machines, and they can be adapted as needed to accommodate stamps for a micron-scale or nanoscale process. Other terms used in the art for stamping instruments including stamping machines, imprinting machines, marking machines, presses, and the like. Instruments are particularly of use when they are adapted to process pharmaceutical compositions and be in compliance with federal regulations for pharmaceuticals. The instrument generally comprises mechanical and electrical components which continuously and automatically deliver an object such as a pill or a tablet for stamping to a stamping site. The instrument also generally comprises mechanical and electrical components which provide for stamping of the object at the stamping site. The instrument further comprises mechanical and electrical components which continuously and automatically transport the object away from the stamping site after stamping. As known in the art, conveyor systems can be used to transport the objects in a continuous, high-speed, manufacturing operation. The instruments also can comprise components which provide for printing, sorting, inspecting, and feeding. The stamping methods generally can be coupled with other methods used to process pharmaceutical compositions.

Some examples from the technical literature are noted, and the complete disclosures of these following patents are incorporated herein by reference in their entirety for their description of instrumentation for processing of compositions including pharmaceutical compositions.

For example, U.S. Pat. Nos. 5,023,437 and 4,591,279 to Speicher et al. are incorporated by reference in their entirety and describe marking the surface of objects with bar codes, including a marking machine. U.S. Pat. No. 4,574,694 is incorporated by reference in its entirety and also describes a stamping machine.

U.S. Pat. No. 4,189,996 to Ackley et al. is incorporated by reference in its entirety and describes an apparatus adapted to transport and imprint indicia around the circumference of generally cylindrical objects such as capsules. See also U.S. Pat. No. 3,272,118 to Ackley et al which is incorporated by reference in its entirety. Additional patents assigned to Ackley include U.S. Pat. Nos. 5,630,499; 5,878,658; 6,286,421; 6,314,876; 6,450,089; and 6,481,347, which are incorporated by reference in their entirety.

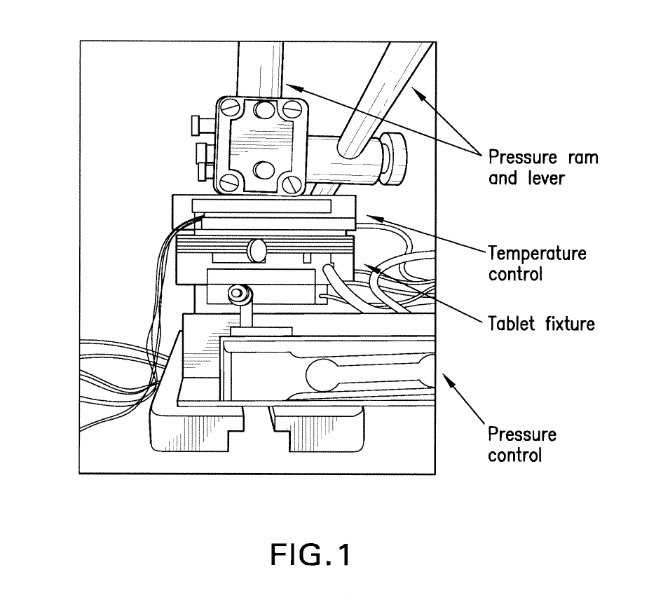

U.S. Pat. No. 5,376,771 to Roy is incorporated by reference in its entirety and describes a high speed process for digital laser marking of pharmaceutical compositions including an instrument in FIG. 1.

Stamping instruments and components including tablet presses including rotary tablet presses are available from a variety of companies including, for example, Ackley Machine Corp. (Moorestown, N.J.); R.W. Hartnett Co. (Philadelphia, Pa.); CapPlus Technologies (CPT); and Fette Compacting America (Rockaway, N.J. & Schwarzenbek, Germany).

In addition, see, e.g., stamping instruments and components from companies marketing NIL including Suss Microtech AG (Garching/Munich Germany); EV Group (Schareding, Austria); Nanonex Corp. (Princeton, N.J.); Molecular Imprints (Austin, Tex.); and Obducat (Malmo, Sweden).

For an automated stamping instrument, the production rate for stamping can be controlled to provide the best balance of quality and speed. The production rate for stamping can be, for example, at least 1,000 units per hour, or at least 10,000 units per hour, or at least 100,000 units per hour, or at least 1,000,000 units per hour.

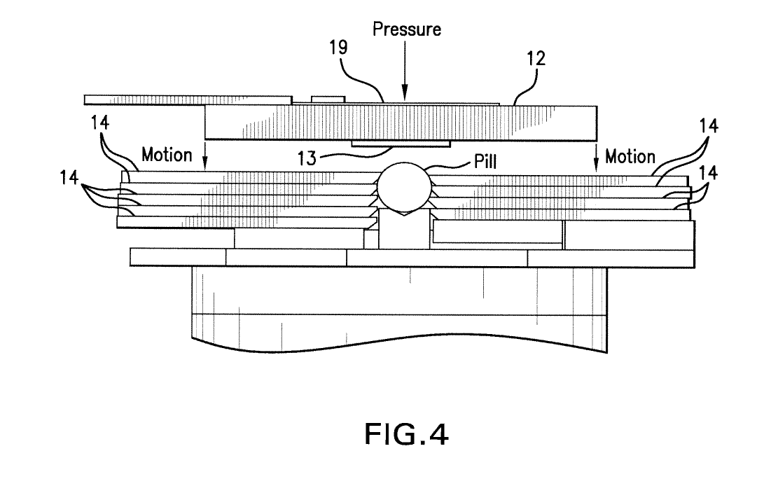

A stamping instrument can be constructed as further illustrated in FIGS. 1-5. This instrument can be adapted to provide continuous operation under automated conditions with computer control. Using the apparatus shown in FIG. 1, for example, various pill surfaces can be imprinted with a silicon stamp. Time for stamping, pressure, and temperature can be optimized by stamping under a range of conditions (e.g., Time=0.5 s to 30 s, T=60° C. to 130° C. or to 150° C., Pressure=1 MPa to 27 MPa or 1 MPa to 60 Mpa or 1 MPa to 100 MPa).

The stamping instrument can comprise (i) a device which is adapted to be coupled to a stamp; (ii) a mount which is adapted for holding an object or composition, wherein the device and the mount are operably connected to provide relative motion and stamping of the object or composition by the stamp.

A stamp can be coupled to the device and uncoupled from the device, and replaced as desired with a different stamp. Hence, a stamp can comprise not only a surface having the image to be stamped but also, if desired, coupling features which allow coupling of the stamp to the device.

A support structure can be used to operably connect the device and the mount and assist in providing the relative motion and stamping. For example, the support structure can comprise a ram bearing and a pressure ram. The support structure can include an operably connected pressure ram which can move in relation to the support structure through, for example, a ram bearing and provide motion of the stamp relative to the mount. The support structure can also comprise a heater, for controlling temperature of the stamping, and a stamp holder. The mount can be connected to the support structure through a press base. The mount can comprise components which hold the object or composition to be stamped such as, for example, one or more holding jaws. The support structure can also comprise a damping element such as a spring which provides for force and pressure measurement. As stamping is carried out, and pressure is generated and released, the pressure of stamping can be measured via the damping element. One or more measurement devices to measure pressure, temperature, time, or other experimental variables can be operably coupled to the instrument. Computers, including hardware, software, and data storage can be operably coupled to the instrument.

The composition can be a pharmaceutical composition.

More particularly, the stamping instrument can comprise (i) a stamping force application device which is adapted to be coupled to a stamp for stamping an object, a composition, or a pharmaceutical composition, (ii) a mount for holding the object, the composition, or the pharmaceutical composition to be stamped, wherein the stamping force application device and the mount for holding the object, the composition, or the pharmaceutical composition are operably connected to provide measurement of stamping conditions and relative motion for stamping. The force application device, for example, can comprise a press support structure, a pressure ram, and a ram bearing as described further below. The mount for holding the object can be adapted to provide for damping and measurement of force and pressure.

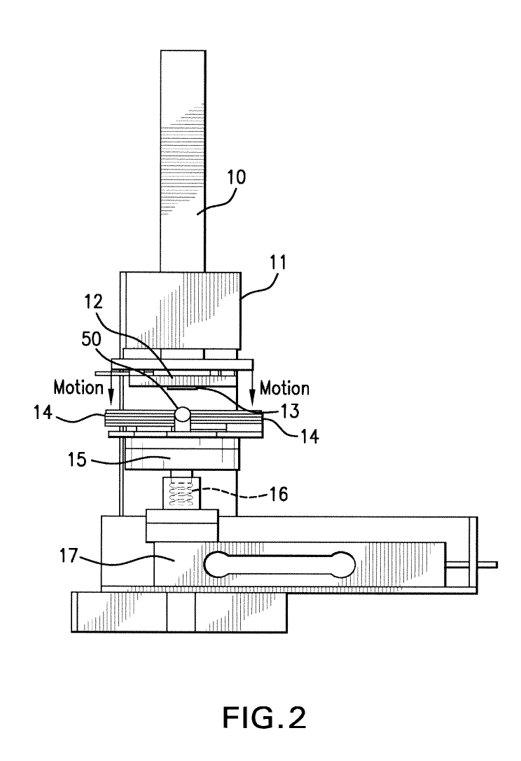

FIGS. 2-4 illustrate one embodiment of an apparatus for applying by stamping at least one identification region having at least one identification feature to pharmaceutical compositions consistent in the present invention.

As shown in FIG. 2, the apparatus can have a pressure ram 10 housed in a ram bearing 11. A heater/stamp holder 12, which can hold the stamp 13 and heat it if desired to a desired temperature, can be connected at one end of the pressure ram 10 and can be positioned over the pharmaceutical composition to be stamped, which is shown as a pill (50). This pharmaceutical composition can be held in place by a pharmaceutical composition mount 14, which is shown as jaws, positioned under the heater/stamp holder 12.

The pharmaceutical composition mount 14, shown as jaws, can be mounted on a press base 15. This press base 15 can be in turn connected to an internal press base spring 16 and a load cell 17.

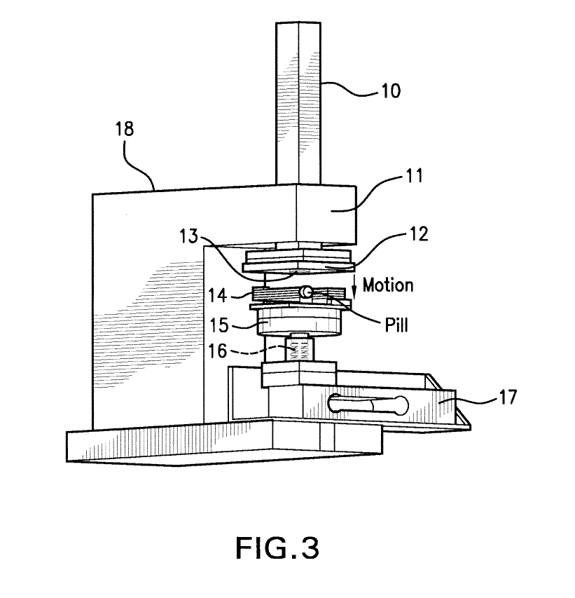

The apparatus shown in FIG. 2 can be operated by moving the pressure ram 10 in a downward direction guided by the ram bearing 11, which can be part of a support structure 18 not shown directly in FIG. 2 but shown in FIG. 3. The stamp 13 mounted on the heater/stamp holder 12, which is mounted on the pressure ram 10, is thereby pushed into the pharmaceutical composition, shown as a pill, which is held by the pharmaceutical composition mount 14. The force applied to the pharmaceutical composition held by the pharmaceutical composition mount 14 compresses the internal press base spring 16. The press base spring 16 dampens the force applied to the pharmaceutical composition. The load cell 17 measures the amount of force applied to the pharmaceutical composition. Thus, the load cell 17 can be used to apply a desired and consistent amount of force to the pharmaceutical composition with a large degree of sensitivity. The heater element in 12 may be used to heat the stamp if desired to aid the stamping process.

FIG. 3 further shows in a perspective view the apparatus including the press support structure 18. which holds the ram bearing 11.

The apparatus may be operated manually by a user, or it may be operated by electronic, computer, or automatic control in a production environment. Preferably, the load cell is used to apply a consistent amount of force. Specifically, the force applied to the pharmaceutical composition preferably should be a specific amount held for some set period of time or released immediately once the predetermined force is applied. The desired force will vary depending on the pharmaceutical composition to be stamped. One skilled in the art can perform experiments to find an optimal force profile for stamping depending on the characteristics of the pharmaceutical composition being stamped. Production rate and intended stamp life can be other important factors in selecting stamp conditions.

In many circumstances, it may be desirable to use heat in combination with force to stamp. For this reason, in some embodiments, as shown in FIG. 3, the apparatus can have a heating element 19 that may be used to heat the stamp directly through the heat/stamp holder 12. FIG. 3 shows how the heating element (19) can be mounted on the heater/stamp holder to heat the stamp. Heat can also be applied to the pharmaceutical composition via an environmental chamber or via the pharmaceutical composition mount 14 which is shown as jaws in FIG. 3. Like the force, the desirability of heat and the amount and duration of heat to apply will vary with the pharmaceutical composition. Exemplary stamping temperatures and pressures are described above. One skilled in the art can perform experiments to find optimal heating conditions for stamping. Cold stamping can be carried out.

The pharmaceutical composition mount 14 may hold non-wafer form pharmaceuticals, such as cylindrical pills and capsules. FIG. 3 shows one embodiment where the pharmaceutical composition mount is constructed from parallel plates placed on top of one another. The parallel plates are split down the middle to create a space to hold a pharmaceutical form. Each of these parallel plates may be adjusted independently to hold a variety of shapes including cylinders, disks, and other non-wafer shapes. This ability to hold pharmaceutical forms of varying shapes is valuable, because pharmaceutical compositions are manufactured in a number of different forms. Any number of other mechanisms to suitably hold non-wafer pharmaceutical forms can be used by one skilled in the art and considered within the scope of the invention. Such alternative mechanisms can hold non-wafer pharmaceutical forms securely enough to allow stamping. At the same time, such alternative mechanisms should minimize damage to the pharmaceutical form. Preferably, a user can adjust the pharmaceutical composition mount to accommodate a variety of pharmaceutical forms. Such alternative mechanisms, for example, could use vacuum suction to hold the pharmaceutical form. In another embodiment a cut-out shape can be used to hold the pharmaceutical form using mechanical pressure from the stamp side.

The press base spring 16 can add sensitivity to the apparatus by dampening the force applied to the pharmaceutical form by the pressure ram. Thus, breakage and other damage to the pharmaceutical forms to be stamped may be reduced or eliminated. The tension of the spring may be selected by one skilled in the art to provide the proper amount of dampening. In some embodiments, the single spring may be replaced by multiple springs or other dampening members. For example, the single spring illustrated in FIG. 2 may be replaced by a hydraulic member in some embodiments. This hydraulic member may provide a similar dampening function as the spring illustrated in FIG. 2. The apparatus can contain dampening members readily selected by one of ordinary skill in the art to dampen the force applied to the pharmaceutical form being stamped.

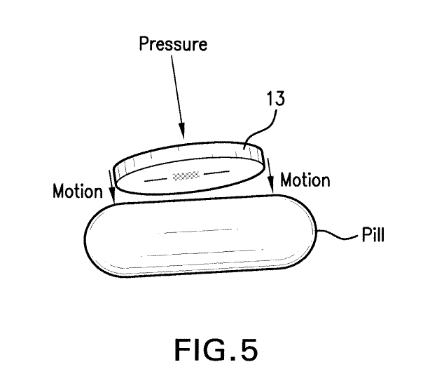

FIG. 5 shows the stamp in motion to contact the pharmaceutical composition, wherein the stamp is smaller than the pharmaceutical composition. For example, the stamp can be about 1 mm squared or less, or about 0.8 mm squared or less, or about 0.6 mm squared or less, or about 0.4 mm squared or less. The stamp can be, for example, rectangular in shape, for example, about 1 mm×0.4 mm or about 1 mm×0.6 mm or about 1 mm×0.8 mm.

Other modifications may be made to the apparatus described above by one of ordinary skill in the art. For example, the pharmaceutical composition mount may hold more than one pharmaceutical composition. This modification may allow multiple pharmaceutical compositions to be stamped simultaneously, or it may allow multiple pharmaceutical compositions to be stamped without needing to remount additional pharmaceutical compositions. In another embodiment, the heater/stamp holder may hold more than one stamp so that multiple pharmaceutical compositions may be stamped simultaneously. In the alternative, the multiple stamps may be used to allow a user to switch stamps without needing to manually replace the existing stamp. In another embodiment, the pressure ram or the pharmaceutical form mount may be designed to move in the x-y plane. This modification may allow pharmaceutical compositions positioned at different locations on the pharmaceutical form mount to be stamped. These and other modifications may be made by one skilled in the art and are within the scope of the present invention.

In a preferred embodiment, the instrument shown in FIGS. 1-5 comprises the stamps described above and are operated in continuous, automated mode under computer control at high production speeds.

### Stamping Instrument Part II: Additional Description

Additional embodiments are provided for a stamping instrument comprising: (i) a device adapted for coupling with a stamp, and (ii) a mount for holding an object or composition, wherein the device and the mount are operably coupled for relative motion of the stamp and the object or composition and for stamping the object or composition with the stamp. In addition, a combination of two subsystems is provided to increase the level of automation and precision: (1) a motorized mechanical actuation subsystem, and (2) a temperature-regulated stamping subsystem which is adapted for holding and heating the stamp. For purposes of this patent application, the inventive features do not reside in the method of making the stamps.

### Embodiment 1: Semi-Automated Stamping Apparatus

A first embodiment provides a (semi)automatic, motorized apparatus capable of reproducibly stamping, embossing, debossing or engraving e.g., a pharmaceutical composition. Programming of and precise control over the position and speed of the stamping assembly are of particular interest.

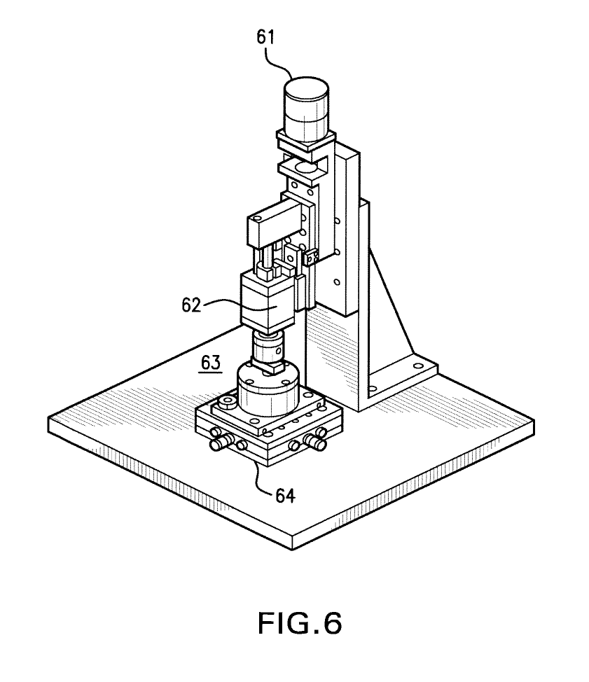

FIG. 6 is an overview of an embodiment for the semi-automated stamping apparatus. The different functional blocks are shown with different shades of gray for easy reading. The instrument, in this representative embodiment, comprises a precision, motorized mechanical actuation subsystem (10), which vertically translates at a known speed and to known positions a temperature-regulated subsystem (20). The temperature-regulated part holds and heats a stamp that presses against a pharmaceutical composition such as, for example, a tablet held in place by assembly 30. Stage 40 aligns the pharmaceutical composition such as, for example, the tablet assembly and tablet underneath the stamp assembly.

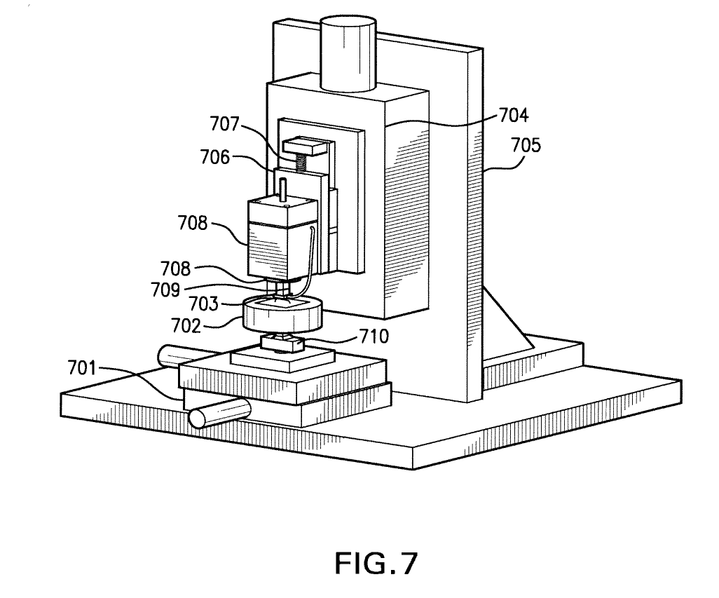

FIG. 7 is a more detailed schematic diagram of an embodiment of the semi-automated stamping apparatus. A manually controlled two-axis (XY) stage (18) holds a tablet insert nest (19), in which a tablet insert (20) may be introduced. Said tablet insert provides a pocket that holds a tablet, capsule or other object. Multiple types of tablet insert may be custom-machined or molded to fit the exact shape of multiple sorts of tablets. To hold the tablet in place, a vacuum is provided to the pocket, the vacuum line (not visible on this drawing) connecting to the back of the tablet insert nest. The one-axis (Z) motor stage (14) mounted on the cantilevered frame (16) moves up-and-down an assembly composed of the linear bearing (10; Misumi Corporation), the spring (9) and the collet holder block (7).

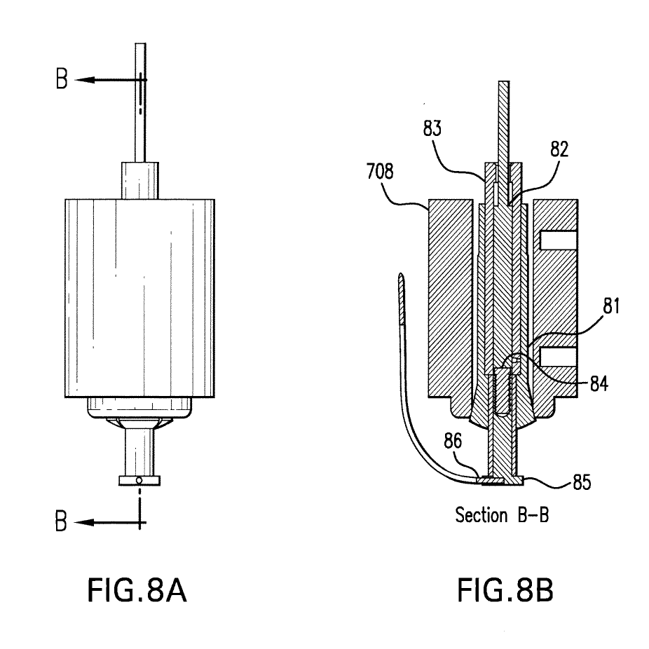

Referring now to FIG. 8, an embodiment is shown wherein, for example, the collet block (7) holds under pneumatic control a commercial collet (2), in which a stamp heating assembly has been placed. Said assembly comprises a cylindrical 250 W heater (4) (Omega Engineering) and thermally conductive copper sleeve (28) mechanically holding a stamp insert by an aluminum screw (27). A commercial P.I.D. controller (Omega Engineering) and sensor temperature display form the temperature control electronics. The stamp insert is composed of an aluminum core (6), optional machineable ceramic shield (5) (not shown in FIG. 8 but shown in FIG. 7) and temperature sensor (29). When inserted into the collet, the stamp insert is in thermal contact with the heater/copper sleeve. This design uses readily available commercial parts and allows the rapid replacement/interchange of the stamp insert/stamp.

Referring back to FIG. 7, in operation, the motor stage (14) brings the heated stamp, which has been glued on the bottom part of the stamp insert (6), in contact with the tablet (aligned with the help of 18). The use of a motorized stage driving a second stage downward via spring connection 9 allows a gradual, accurate application of force and allows higher throughput and greater stamping uniformity. The apparatus is usually calibrated before processing a batch by determining the approximate location of the contact point between the stamp and the pharmaceutical, tablet with a test unit, the stamp heater being turned off. A load cell (23), found between the stage (18) and the tablet insert nest (19), measures forces applied to the tablet by the stamp and may be used as a contact indicator for calibration purposes.

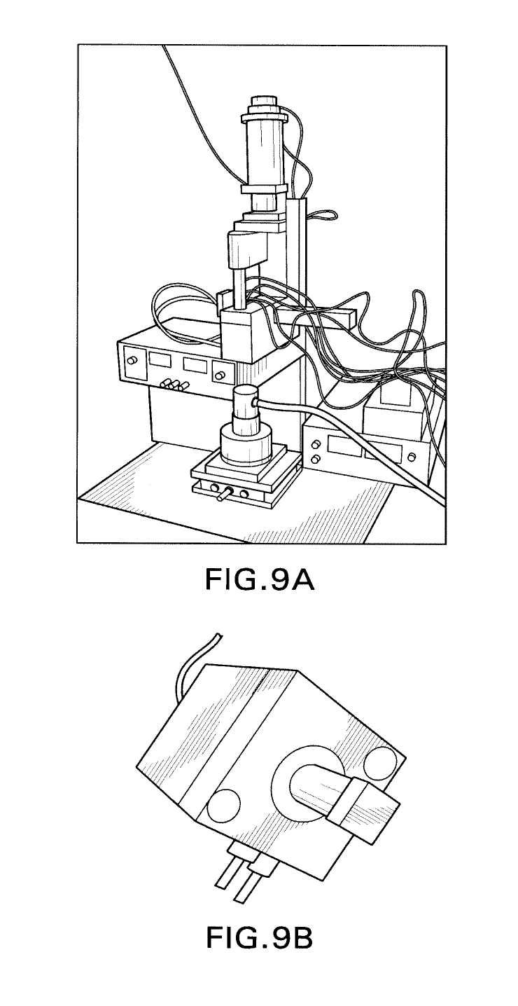

An exemplary prototype of said (semi)automated stamping apparatus and said collet block and stamp heating assembly is shown in FIGS. 9A and 9B, respectively. This system may be used for:
Proof-of-concept work and pilot-plant work,
Parameter space exploration (pressure, contact time, temperature),
Production of medium quantities (>100) of encoded pharmaceutical units for e.g. statistical testing and environmental testing.

### Embodiment 2: Semi-Automated Stamping Apparatus Capable of Controlling the Load Profile During Stamping

The apparatus described in Embodiment 1 above may be operated in open loop, meaning that the stamp is brought in contact with and driven into, for example, a pharmaceutical composition or tablet for a known distance. With knowledge of the spring constant of 9 (FIG. 7), one may coarsely estimate the value of the applied load (thus the average pressure, knowing the surface area of the stamp) during stamping. However, the effective load (and possibly the quality of the stamping) may be sensitive to variations in the external dimensions and/or hardness from tablet to tablet as well as the actual sprint constant of individual springs used in the array of stamphead elements. In a second, preferred embodiment, the invention provides a semi-automated or automated stamping apparatus with improved control over loading. For example, an embodiment of the invention provides a semi-automated or automated stamping apparatus that operates in close loop mode, meaning that the load cell signal is fed back into the vertical motion/stamping control electronics to keep the load to a desired value or along a desired program versus time.

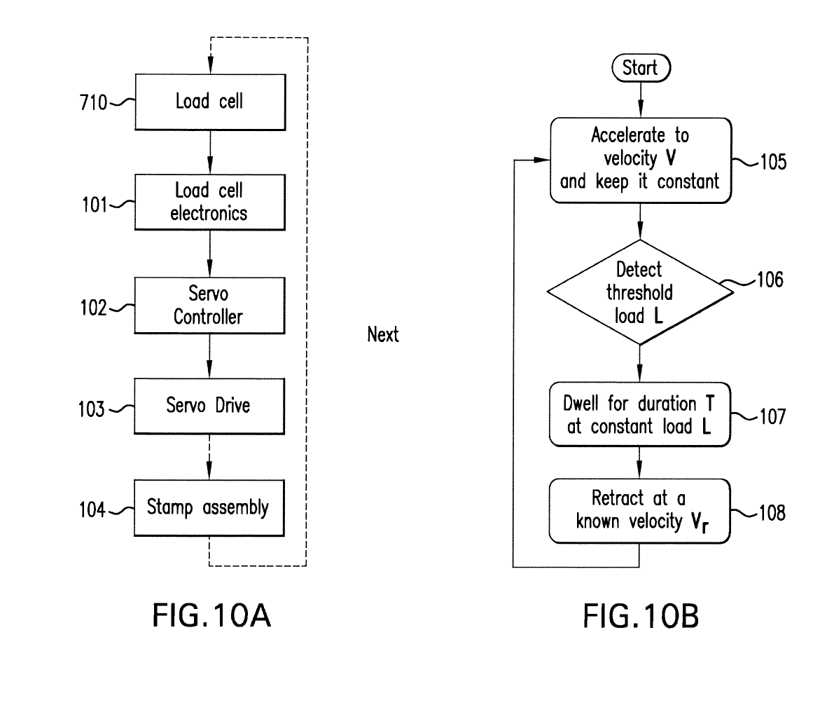

FIG. 10[A] illustrates schematically an exemplary hardware setup. In this example, the cell (10) and its associated amplification electronics (15) generate an analog signal proportional to the load. This signal is fed to the analog input of the servo control system (20; Galil Motion Control, Inc. Rocklin, Calif.) that drives the motorized slider (25), which is in turn mechanically connected to the stamp assembly (30).

The servo control system can implement, for example, the stamping control algorithm illustrated in FIG. 10[B]. The user can then select the following parameters: the indentation velocity V (which determines the loading increase rate), the threshold load L, the contact time T and the retract velocity V, (which determines the loading decrease rate). When the stamping cycle starts, the stamp assembly is accelerated downwards until reaching the desired velocity V (105). The stamp speed is then kept constant. Because of the spring 9, the load increases in a substantially linear manner after contact with the pharmaceutical unit. When the load reaches the threshold value L (110), the stamp is kept in contact with the pharmaceutical unit for the duration T (115) while maintaining the load constant. The stamp assembly is then retracted at the retract velocity V, and repositioned to its initial (rest) location.

Persons of ordinary skill in the art will acknowledge the existence of multiple equivalents of the hardware configuration and algorithm hereby disclosed. Such variations are intended to be covered by the present invention.

### Embodiment 3: Parallel, Highly Scalable Stamp Head Featuring Modular Elements and Inexpensive Stamp Holders

The stamping apparatuses in previous embodiments operate in a substantially serial manner, e.g., one tablet at a time. In a third embodiment, the invention provides a parallel stamping head for a high-throughput, high-volume automated stamping instrument. It can be a mechanical assembly that may substantially simultaneously contact multiple stamps with multiple (pharmaceutical) units. The design of the stamp head is preferably scalable, meaning no major rework is necessary when increasing the number of stamps per head.

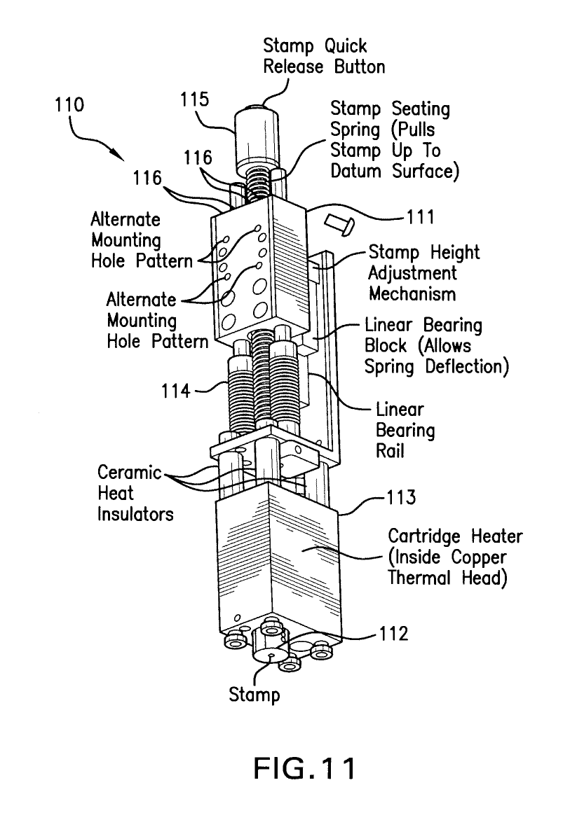

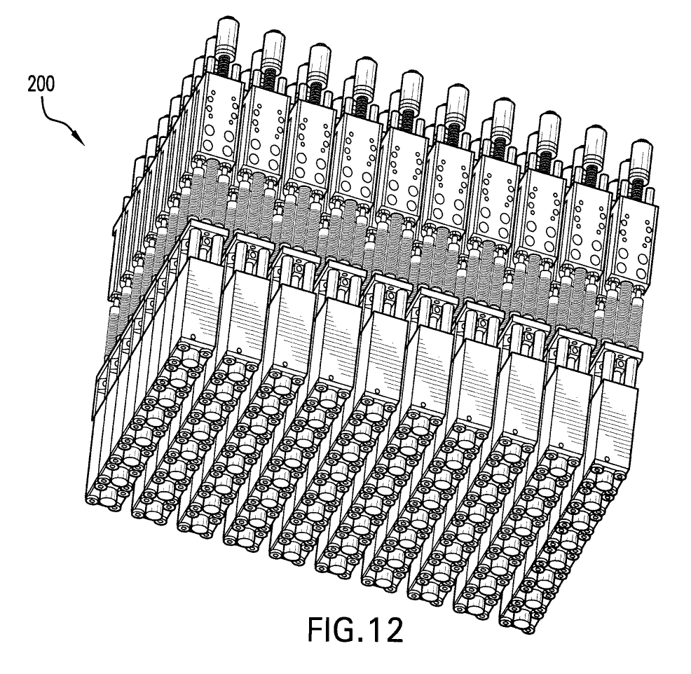

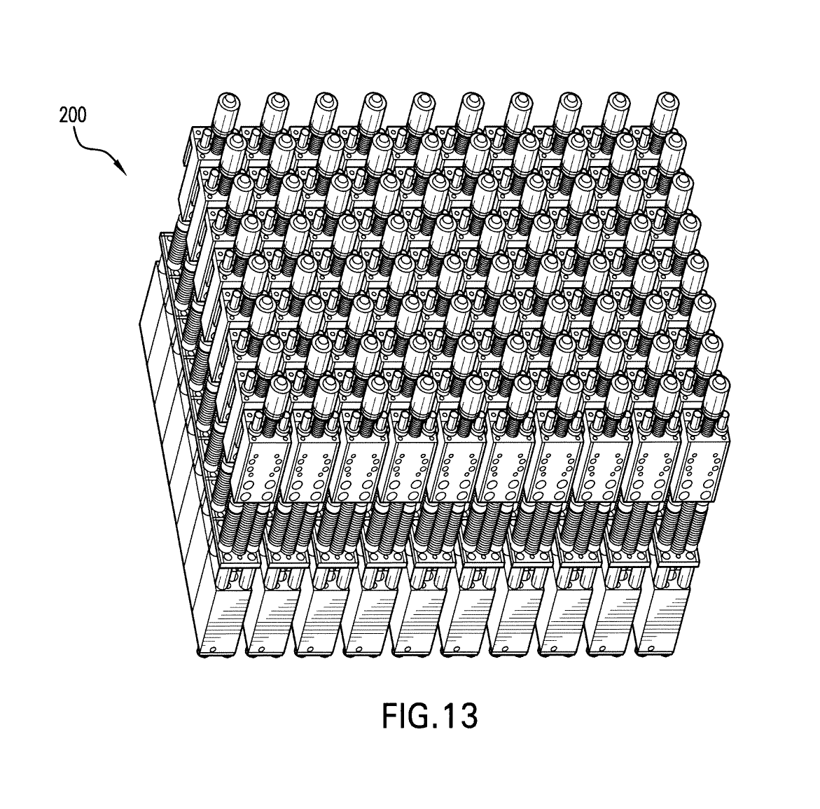

For example, FIG. 11 is a schematic diagram of a modular, compact stamping element (10) that can be ganged-up in a square or rectangular array (FIGS. 12 and 13). This stamping element comprises in one embodiment: a mounting block (15); an easily removable stamp holder (11; see explanation below) that carries a micro- or nanofabricated stamp; a temperature-control block (25, 30) in good thermal contact with said stamp holder; and a spring-and-rail subsystem (18, 20) which compensates for variations in the height of the tablets or for parallelism errors between the stamp head and the tablet holder, should they arise. Individual measurement and control of the individual load at the stamp element are optional. For example, rather than having a single motor driving the entire ganged array of heads up and down, an array of small linear motors or ballscrew drives may be integrated with and drive each head individually.

The temperature-control block comprises a heating cartridge, a copper thermal diffuser block, a thermocouple and a set of ceramic or metallic insulators that isolate the heated block from other mechanical parts. Individual control of the temperature of each block within an array is possible.

An optional spring-loaded, quick-release mechanism (12; Kwik-Lok™, Jergens, Inc. Cleveland, Ohio) provide for the rapid changeover of stamp holders when pushing the top button.

The stamping elements may be bolted together to a top or side plate via the upper or side mounting holes (14) on the primary mounting block.

FIGS. 12 and 13 are the bottom and top perspective views, respectively, of an eighty-element rectangular assembly of stamping elements 200.

### Part III: Stamp Holders and Transportation Devices (Embodiment 4)

The stamping instrument can comprises a stamp holder as described further in this section. In addition, a device can be provided for transportation of a plurality of stamp holders.

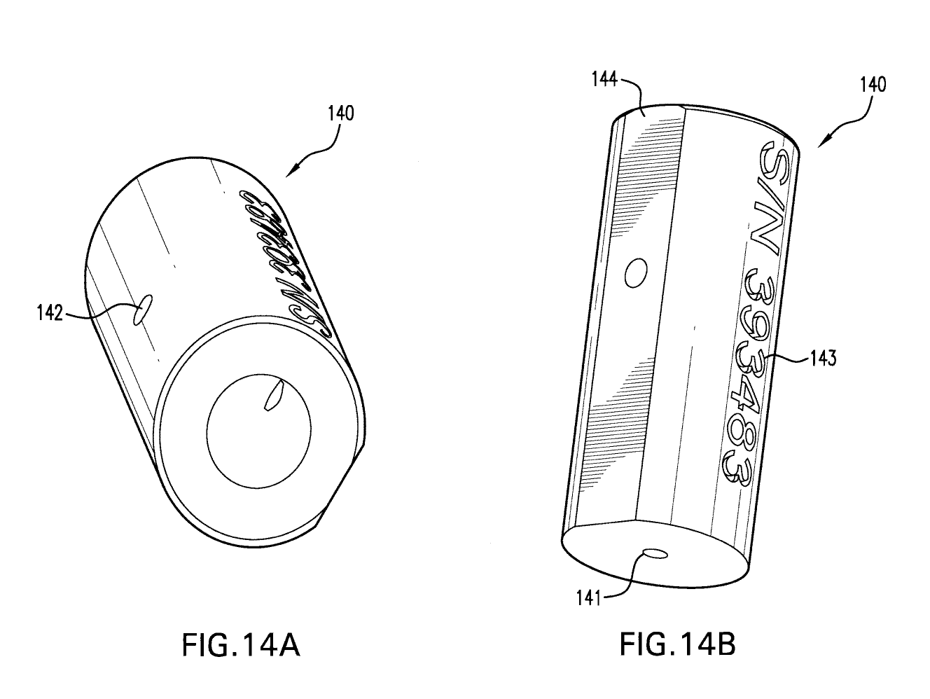

FIGS. 14A and B show different perspective views of an inexpensive stamp holder (11) that may be mass-produced for use with the highly parallel and scalable stamp head described above. The stamp holder allows easy manipulation of the stamp piece, which would otherwise be too fragile and too small for direct handling. It may comprise a highly thermally conductive (preferably copper) tube that is essentially hollow along its length except at one end, where at least one micro- or nanofabricated stamp (31) is glued e.g., with a high-temperature, FDA/USDA-approved epoxy glue. It is also preferably easily (re)connectable to a stamping element. Two small, diametrically opposed holes 51 drilled near its middle mate with the quick release mechanism. A spring pulls the stamp holder against a recess within the stamping element, guaranteeing reproducible positioning. The stamp holder slips inside the heating element to ensure good thermal contact and thus minimum temperature gradient between the stamp and the temperature sensor of the stamping element. A unique identifier (e.g. a serial number, 21) may be engraved on the stamp holder's side for easy recognition. The invention also provides a device that aligns a set of stamp holders in the geometry of the stamp head, facilitating the connection of said stamp holders to the corresponding elements. A flat 41 may be provided for easy alignment of the stamp holder with both its mating stamp element and said alignment device. It also provides devices and methods to safely transport an array of stamp holders without damage to the external surface of the stamps.

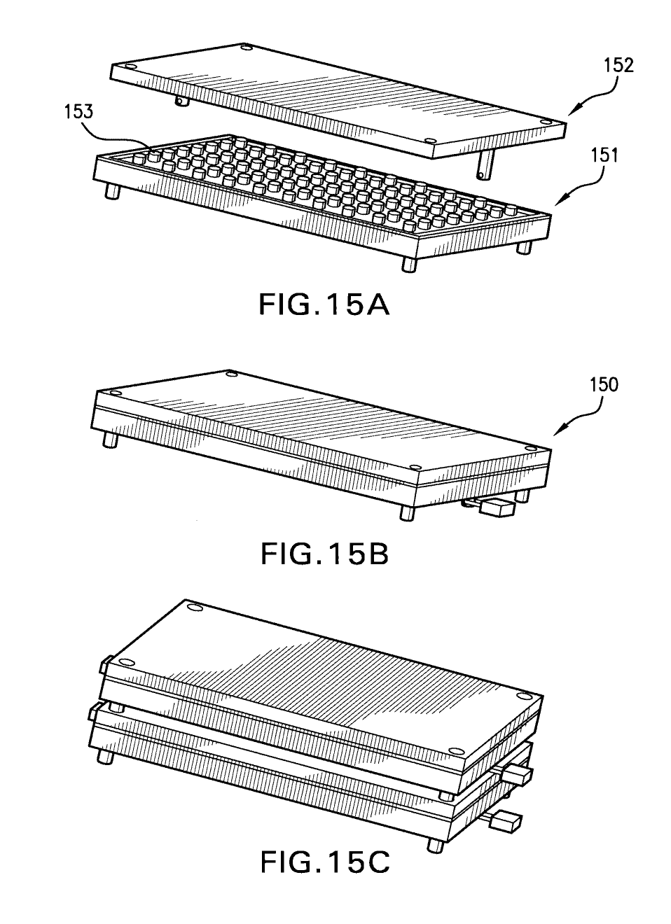

FIG. 15 illustrates a possible device for the alignment, storage and secure transportation of sets of stamp holders according to FIG. 14: In this example, it comprises a sealed, reinforced case 50 that may be securely locked and that can be stacked with others during transportation and storage. The top and bottom parts 52 and 54 have arrays of holes suitable for housing an array of stamp holders (as shown in 56) in a configuration that matches that of the stamp head. Recessed edges (not shown) may be machined in each hole, so that (i) the stamp on the stamp holder cannot be accidentally destroyed by contacting e.g. the hole bottom and (ii) the stamp holder sits in the proper orientation.

### Embodiment 5: Manufacturing Method

In another embodiment, the invention provides a method for manufacturing with a high throughput a large volume of (pharmaceutical) objects and compositions having at least one identification region, said identification region having at least one micro- or nanofabricated identification feature. A preferred method of manufacture includes the steps of: providing an array of stamps; providing a matching array of objects or compositions and especially pharmaceutical compositions; emboss, deboss, engrave said objects or compositions with said stamps in parallel. In a preferred embodiment, the invention provides a method for substantially simultaneously stamping at least two pharmaceutical compositions (and especially at least 9 pharmaceutical compositions or more and especially 80 pharmaceutical compositions or more) in a parallel fashion.

### Embodiment 6: Methods Including Business Method for Managing Stamp Sets and Associated Identification Information

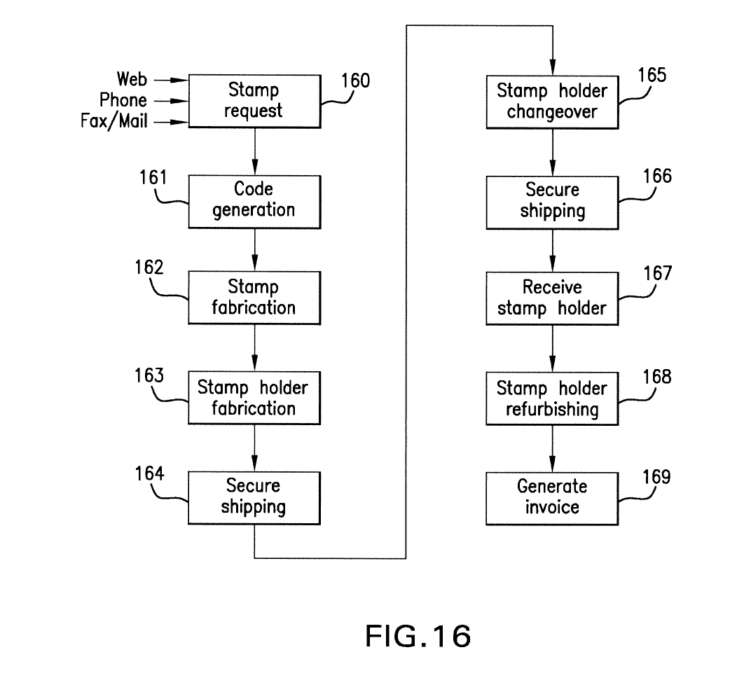

In a final embodiment, the invention provides a business method for managing sets of stamps and the associated information and accessories. It comprises producing stamp sets and distributing them to the owners of high-throughput stamping machines. Referring now to FIG. 16, the owner of a stamping machine for making pharmaceutical compositions having at least one identification region places a request for a stamp or set of substantially identical stamps (10). A code is generated (15) and associated with owner data, which may include but is not limited to the manufacturer name or customer number, plant location, target batch number, manufacturing date, etc. The code is preferably unique and uniquely associated with said data and said stamp set. In a preferred embodiment, the code is generated by a software algorithm, for example, a hashing algorithm or a unique number generator. The code may be stored in a database for later retrieval during the decoding process. The code may be converted in an equivalent pattern design suitable for nanofabrication, transfer into a stamp material, transfer into a pharmaceutical composition, and later decoding. For example, the code may be converted into a bar code, data matrix, set of alphanumeric characters, etc. Next, a number of substantially identical micro- and/or nanofabricated stamps preferentially bearing the same pattern are fabricated (20). The micro- and/or nanofabricated stamps are mounted on appropriate stamp holders (25), forming a set of stamp holders.

The completed assemblies are shipped securely (30) to the owner's site, where the target stamping machine is retrofitted with said stamp set (35). Optionally, the previous set of stamp holders (if it exists) is securely returned to the stamp manufacturing site (40), where the stamp holders and associated stamps are accounted for (45) and the stamp holder refurbished (50). For example, the stamp substrates bearing the code may be separated from their stamp holders and irreversibly destroyed or securely stored; the stamp holder may be recycled in step 25. The steps 40, 45, 50 guarantee that the used stamp set does not fall into the hands of a counterfeiter or other malevolent agent. Finally, a commercial invoice and associated tracking documentation is generated (55).

In variants of that process, a set of stamps bearing substantially different codes or multiple sets of substantially identical stamps may be fabricated and used to stamp a given batch of pharmaceutical compositions, provided that the information born by the stamps or stamp sets is substantially uniquely associated with customer data. This business process may be fully and partially automated using a suite of software tools and routines, enabling high-throughput and rapid turn-out.

Those skilled in the art will acknowledge the existence of multiple functionally equivalent variants of the present embodiment which shall not be considered distinct from the present invention. For example, the high-throughput apparatus used for highly parallel hot stamping of pharmaceutical compositions may be used to emboss, deboss, engrave and/or print with ink pharmaceutical compositions or other objects or compositions. In addition, methods and apparatus also apply to medical devices and containers.

### Further Literature to Practice the Invention

The following patents and co-pending applications, which described patterning technology down to the nanoscale, are hereby incorporated by reference in their entirety and can be used, for example, in fabricating stamps:
1. U.S. Provisional Application 60/115,133 filed Jan. 7, 1999 (“Dip Pen Nanolithography”) to Mirkin et al.
2. U.S. Provisional Application 60/157,633 filed Oct. 4, 1999 (“Methods Utilizing Scanning Probe Microscope Tips and Products Therefor or Produced Thereby”) to Mirkin et al.
3. U.S. Regular patent application Ser. No. 09/477,997 filed Jan. 5, 2000 (“Methods Utilizing Scanning Probe Microscope Tips and Products Therefor or Produced Thereby”) to Mirkin et al.
4. U.S. Provisional Application 60/207,713 filed May 26, 2000 (“Methods Utilizing Scanning Probe Microscope Tips and Products Therefor or Produced Thereby”) to Mirkin et al.
5. U.S. Provisional Application 60/207,711 filed May 26, 2000 (“Methods Utilizing Scanning Probe Microscope Tips and Products Therefor or Produced Thereby”) to Mirkin et al.
6. U.S. regular application Ser. No. 09/866,533 filed May 24, 2001 (“Methods Utilizing Scanning Probe Microscope Tips and Products Therefor or Produced Thereby”) to Mirkin et al.
7. U.S. Patent Publication 2002/0063212 A1, published May 30, 2002 (“Methods Utilizing Scanning Probe Microscope Tips and Products Therefor or Produced Thereby”) to Mirkin et al.
8. U.S. Patent Publication 2002/0122873 A1 published Sep. 5, 2002 (“Nanolithography Methods and Products Produced Therefor and Produced Thereby”).
9. PCT Publication WO 00/41213 A1 published Jul. 13, 2000 based on PCT application no. PCT/US00/00319 filed Jan. 7, 2000 (“Methods Utilizing Scanning Probe Microscope Tips and Products Therefor or Produced Thereby”).
10. PCT Publication WO 01/91855 A1 published Dec. 6, 2001 based on PCT application no. PCT/US01/17067 filed May 25, 2001 (“Methods Utilizing Scanning Probe Microscope Tips and Products Therefor or Produced Thereby”).
11. U.S. Regular patent application, Ser. No. 10/307,515 filed Dec. 2, 2002 to Mirkin et al. (“Direct-Write Nanolithographic Deposition of Nucleic Acids from Nanoscopic Tips”).
12. U.S. Regular patent application, Ser. No. 10/320,721 filed Dec. 17, 2002 (“Patterning of Solid State Features by Direct-Write Nanolithographic Printing”) to Mirkin et al.
13. U.S. Patent Publication 2003/0022470 A1, published Jan. 30, 2003 (“Parallel, Individually Addressable Probes for Nanolithography”) to Liu et al.
14. U.S. Patent Publication 2003/0007242, published Jan. 9, 2003 to Schwartz (“Enhanced Scanning Probe Microscope and Nanolithographic Methods Using Same”).
15. U.S. Patent Publication 2003/0005755 to Schwartz, published Jan. 9, 2003 (“Enhanced Scanning Probe Microscope”).
16. U.S. Regular patent application, Ser. No. 10/366,717 to Eby et al., filed Feb. 14, 2003 (“Methods and Apparatus for Aligning Patterns on a Substrate”).
17. U.S. Regular patent application, Ser. No. 10/375,060 to Dupeyrat et al., filed Feb. 28, 2003 (“Nanolithographic Calibration Methods”).
18. U.S. Patent Publication 2003/049381 A1 to Mirkin et al., published Mar. 13, 2003 (“Methods Utilizing Scanning Probe Microscope Tips and Products Therefor or Produced Thereby”).
19. U.S. Patent Publication 2003/0068446 A1, published Apr. 10, 2003 to Mirkin et al. (“Protein and Peptide Nanoarrays”)
20. U.S. Patent Publication 2003/157254 A1, published Aug. 21, 2003 to Mirkin et al. (“Methods Utilizing Scanning Probe Microscope Tips and Products Therefor or Produced Thereby”).
21. U.S. Patent Publication 2003/162004 A1, published Aug. 28, 2003 to Mirkin, Dravid, Su, Liu (“Patterning of Solid State Features by Direct-Write Nanolithographic Printing”).
22. U.S. Pat. No. 6,635,311 issued Oct. 21, 2003 to Mirkin et al. (“Methods Utilizing Scanning Probe Microscope Tips and Products Therefor or Produced Thereby”).
23. U.S. Pat. No. 6,642,129 issued Nov. 14, 2003 to Liu et al. (“Parallel, Individually Addressable Probes for Nanolithography”).
24. U.S. Pat. No. 6,674,074 issued Jan. 6, 2004 to Schwartz (“Enhanced Scanning Probe Microscope”).
25. U.S. Patent Publication 2004/008330 A1 published Jan. 15, 2004 to Mirkin, Lim (“Electrostatically Driven Lithography”).
26. U.S. Patent Publication 2004/028814 A1, published Feb. 12, 2004 to Mirkin et al. (“Methods Utilizing Scanning Probe Microscope Tips and Products Therefor or Produced Thereby”).
27. U.S. Patent Publication 2004/037959 A1, published Feb. 26, 2004 to Mirkin et al. (“Methods Utilizing Scanning Probe Microscope Tips and Products Therefor or Produced Thereby”).
28. U.S. Pat. No. 6,737,646 issued to Schwartz (“Enhanced Scanning Probe Microscope and Nanolithographic Methods Using Same”).
29. U.S. Patent Publication 2004/119490 A1, published Jun. 24, 2004 to Liu et al. (“Parallel, Individually Addressable Probes for Nanolithography”).
30. U.S. Patent Publication 2004/131843 A1, published Jul. 8, 2004 (“Nanolithography Methods and Products Produced Therefor and Produced Thereby”).
31. U.S. Patent Publication 2004/142106 A1, published Jul. 22, 2004 (“Patterning Magnetic Nanostructures”).
32. U.S. Patent Publication 2004/175631 A1, published Sep. 9, 2004 (“Nanometer-scale engineered structures, methods and apparatus for fabrication thereof, and applications to mask repair, enhancement, and fabrications”).

### Priority Application Embodiments

In addition, priority provisional application 60/637,007 filed Dec. 20, 2004 is hereby incorporated by reference in its entirety including the following twenty-eight embodiments which are provided again:

Embodiment 1. A stamping instrument comprising: (i) a device adapted for coupling with a stamp, and (ii) a mount for holding an object or composition, wherein the device and the mount are operably coupled for relative motion of the stamp and the object or composition and for stamping the object or composition with the stamp.

Embodiment 2. The instrument according to embodiment 1, further comprising components for bringing the object or composition to the mount for stamping, and components for bringing the object or composition away from the mount after stamping.

Embodiment 3. An apparatus for forming identification features to pharmaceutical compositions comprising: a pressure ram; optionally, a stamp attached to the pressure ram for imprinting at least one identification feature on a pharmaceutical composition; a mount for holding at least one non-wafer pharmaceutical composition; and a load cell for measuring the amount of force applied to the at least one pharmaceutical composition; wherein the pressure ram presses the stamp against the at least one pharmaceutical composition held by the pharmaceutical composition mount with a desired amount of force as measured by the load cell to form at least one identification feature on the at least one pharmaceutical composition.

Embodiment 4. The apparatus of embodiment 3, further comprising a dampening member connected to the pharmaceutical form mount.

Embodiment 5. The apparatus of embodiment 3, further comprising a heating element in thermal contact with the stamp.

Embodiment 6. The apparatus of embodiment 3, further comprising a heating element in thermal contact with the at least one pharmaceutical composition.

Embodiment 7. The apparatus of embodiment 3, wherein the pressure ram may be moved in the x-y plane.

Embodiment 8. The apparatus of embodiment 3, wherein the stamp imprints more than one identification feature.

Embodiment 9. The apparatus of embodiment 9, wherein the pharmaceutical composition mount holds more than one pharmaceutical composition.

Embodiment 10. The apparatus of embodiment 9, wherein the pharmaceutical composition mount may be moved in the x-y plane.

Embodiment 11. A semi-automated or automated stamping instrument, said instrument comprising: a precision, motorized mechanical actuation subsystem; a temperature-regulated stamping subsystem for holding a stamp; an assembly holding a composition or object; an optional alignment stage to align said composition or object underneath said stamping assembly; wherein the motorized mechanical actuation subsystem translates the temperature-regulated stamping subsystem at a known speed towards and known positions relative to the composition or object.

Embodiment 12. The semi-automated or automated stamping instrument according to embodiment 11, wherein said motorized mechanical actuation subsystem comprises a slider controlled by a servo drive and the temperature-regulated stamping subsystem is connected to said slider via a spring-loading mechanism.

Embodiment 13. The semi-automated or automated stamping instrument according to embodiment 11, where the temperature-regulated stamping subsystem for holding a stamp allows for the removal and replacement of the stamp.

Embodiment 14. The instrument according to embodiment 13, where the stamping subsystem comprises a commercial collet block holding a collet, itself holding a stamp heating assembly for holding said stamp.

Embodiment 15. The instrument according to embodiment 13, further comprising: a load sensor and associated electronics; a device for controlling the motorized mechanical actuation subsystem; so that the load sensor signal is used for controlling the pressure applied by the stamp as a function of time during stamping (including its increase and decrease rates and the contact time of said stamp with said composition or object).

Embodiment 16. A semi-automated stamping instrument, the instrument comprising a substantially vertical slider controlled by a servo drive; a spring mechanism attached to the slider with downward spring-loading from the servo slider to the spring slider to compensate for dimensional tolerances and allow for gradual pressure increase; a temperature-controlled stamp holder supporting a stamp comprising at least one micro- or nanofabricated identification region; and a mating mechanism for the stamp holder.

Embodiment 17. A method for the closed-loop imprinting of identification marks on a composition or object, the method comprising the steps of: providing a stamping instrument comprising a motorized mechanical actuation subsystem and a stamping subsystem; measuring the load applied on a composition or object; feeding its value back to the control system controlling the motorized mechanical actuation subsystem, so that the load or related stamping parameters may be kept at a desired value or according to a desired predetermined program.

Embodiment 18. A method according to embodiment 17, where said program provides the steps of: providing the values for a first velocity, a threshold load, a contact time, and a second velocity; accelerating the stamping assembly until said first velocity is reached; keeping,the speed of said assembly constant until said threshold load is reached; dwelling at constant load for said contact time, and retracting the stamping assembly at said second speed.

Embodiment 19. A method for embossing, debossing, engraving, imprinting, or stamping without ink and/or print with ink micro- or nanoscale identification regions onto or into at least two pharmaceutical compositions in a parallel fashion.

Embodiment 20. The method according to embodiment 19, wherein at least 50 pharmaceutical compositions are processed in parallel.

Embodiment 21. An automated stamping instrument comprising: a high-volume pharmaceutical unit conveyor or rotary table and a parallel stamp head, said stamp head comprising an array of modular stamping elements, said modular stamping elements comprising: a removable stamp holder holding a stamp; an individual temperature-controlled heating block thermally connected to said stamp holder; an individually spring-loaded slide that compensates for pharmaceutical unit and mechanism dimensional variations and allows for a gradual increase and decrease of the stamping pressure, optionally a pressure feedback sensor.

Embodiment 22. The instrument according to embodiment 21, comprising at least 50 modular stamping elements.

Embodiment 23. An inexpensive stamp holder adapted for mounting on a heated stamping element in a stamping instrument, said stamp holder comprising: a body adapted for mechanical connection to said stamping element and for good thermal contact with a heater within said stamping element, a unique identifier, and a stamp.

Embodiment 24. A device for securely transporting and storing an array of stamp holders.

Embodiment 25. A method for high-throughput manufacturing of objects and compositions having at least one identification region, said identification region having at least one micro- or nanofabricated identification feature, the method comprising the steps of: providing an array of stamps; providing a matching array of objects or compositions; embossing, debossing, engraving, imprinting, or stamping said objects or compositions with said stamps in parallel.

Embodiment 26. The method according to embodiment 25, where said objects and compositions are pharmaceutical compositions.

Embodiment 27. The method according to embodiment 25, where at least 80 objects and compositions are processed in parallel.

Embodiment 28. A business method for managing a set of stamps adapted for manufacturing object and compositions having at least one micro- or nanoscale identification region, said method comprising the steps of: upon receiving a request for a set of stamps, generating a code associated with data associated with the request, optionally storing said code in a database for later retrieval, converting the code in an equivalent pattern design suitable for micro- or nanofabrication, fabricating a set of stamps having said pattern, mounting said stamps on appropriate stamp holders, shipping securely the resulting stamp holder set to the manufacturing site, installing the target stamping machine with said stamp set, and optionally securely returning the previously installed set to the stamp manufacturing site, accounting for said stamp holders and associated stamps, refurbishing the stamp holders, comprising the step of irreversibly destroying or securely storing said stamps, and generating a commercial invoice and associated tracking documentation.

1.-35. (canceled)

36. An instrument for stamping a pharmaceutical composition, the instrument comprising:
a pharmaceutical composition holding assembly configured to hold a pharmaceutical composition to be stamped;
a temperature-regulated stamping subsystem configured to hold and heat a stamp that is configured for stamping the pharmaceutical composition; and
a motorized mechanical actuation subsystem configured to translate the temperature-regulated stamping subsystem at a known speed towards one or more known positions relative to the pharmaceutical composition,
wherein the motorized mechanical actuation subsystem and the temperature-regulated stamping subsystem are connected via a spring-loading mechanism.

37. The instrument according to claim 36, further comprising the stamp, wherein the stamp comprises at least one identification region having at least one identification feature, and the at least one identification feature has a lateral dimension of about 100 microns or less.

38. The instrument according to claim 37, wherein the stamp comprises nanoscale identification features.

39. The instrument according to claim 36, wherein the temperature-regulated stamping subsystem configured to hold a stamp with an area of one square millimeter or less.

40. The instrument according to claim 36, wherein the temperature-regulated stamping subsystem is configured to hold and heat an array of stamps for stamping an array of pharmaceutical compositions in parallel.

41. The instrument according to claim 36, further comprising an alignment stage configured for aligning the pharmaceutical composition underneath the stamp.

42. The instrument according to claim 36, wherein the motorized mechanical actuation subsystem comprises a slider controlled by a servo drive, and the temperature-regulated stamping subsystem is connected to the slider via the spring-loading mechanism.

43. The instrument according to claim 36, wherein the temperature-regulated stamping subsystem is configured to allow for removal and replacement of the stamp.

44. The instrument according to claim 36, further comprising:
a load sensor and associated electronics; and
a device configured to control the motorized mechanical actuation subsystem, such that a pressure applied by the stamp to the pharmaceutical composition via the motorized mechanical actuation subsystem is controllable as a function of time using a load sensor signal provided by the load sensor.

45. The instrument according to claim 36, wherein the instrument is adapted for open loop operation.

46. The instrument according to claim 36, wherein the instrument is adapted for closed loop operation.

47. The instrument according to claim 36, wherein:
the temperature-regulated stamping subsystem comprises a collet block, and
the collet block comprises a collet in which a heating assembly is disposed.

48. The instrument according to claim 47, wherein the heating assembly comprises a cylindrical heater.

49. The instrument according to claim 48, wherein the heating assembly further comprises a thermally conductive sleeve disposed around the cylindrical heater.

50. The instrument according to claim 49, wherein the thermally conductive sleeve is configured to hold the stamp.

51. The instrument according to claim 50, wherein the thermally conductive sleeve is configured to hold the stamp via a stamp insert.

52. The instrument according to claim 36, wherein the motorized mechanical actuation subsystem is a Z-motor stage.

53. The instrument according to claim 36, wherein the spring-loading mechanism comprises a spring and a linear bearing.

54. An instrument for stamping a pharmaceutical composition, the instrument comprising:
first means for holding a pharmaceutical composition to be stamped;
second means for holding and heating a stamp that is configured for stamping the pharmaceutical composition; and
third means for translating the second means at a known speed towards one or more known positions relative to the pharmaceutical composition,
fourth means for connecting the second means to the third means.

55. A method comprising:
providing a pharmaceutical composition to be stamped;
providing a stamp configured for stamping the pharmaceutical composition;
providing an instrument comprising:
a pharmaceutical composition holding assembly configured to hold the pharmaceutical composition to be stamped,
a temperature-regulated stamping subsystem configured to hold and heat the stamp, and
a motorized mechanical actuation subsystem configured to translate the temperature-regulated stamping subsystem at a known speed towards one or more known positions relative to the pharmaceutical composition,
wherein the motorized mechanical actuation subsystem and the temperature-regulated stamping subsystem are connected via a spring-loading mechanism; and
stamping the pharmaceutical composition with the stamp using the instrument.
